(19) United States
(12) Patent Application Publication
(10) Pub. No.: US 2003/0147721 A1
(43) Pub. Date: Aug. 7, 2003

(54) Power driven nails for sheathing having enlarged diameter heads for enhanced retention and method

(75) Inventor: Edward G. Sutt JR., Jamestown, RI (US)

Correspondence Address: PILLSBURY WINTHROP, LLP, P.O. BOX 10500, MCLEAN, VA, 22102, US

(73) Assignee: STANLEY FASTENING SYSTEMS, L.P., EAST GREENWICH, RI

(21) Appl. No.: 10/067,150

(22) Filed: Feb. 1, 2002

(51) Int. Cl. F16B 15/08

(52) U.S. Cl. 411/442

(57) ABSTRACT

The present invention provides a nail suitable for sheathing which provides an enhanced resistance to failure. The nail includes an enlarged head as well as a shank having surface deformations. Sheathing panels are secured to a framing structure through the use of the nail. The enlarged head provides a first clamping surface that is seated against an exterior surface of the sheathing panel. The framing structure within which the shank is secured is a second clamping surface. Through the provision of an enlarged head and a shank having surface deformations, the ability of the nail to maintain the securement of the sheathing panel to the framing structure element is enhanced.

Reference is made to co-pending applications DKT SFS-178 REG and DKT SFS-178 REG2, entitled “Packaged Nails Suitable for Sheathing Having Enlarged Diameter Heads for Enhanced Retention,” and “Power Driven Nails for Sheathing Having Enlarged Diameter Heads for Enhanced Retention and Method,” respectively, and both filed on the same day as the present application and hereby incorporated by reference.

### BACKGROUND OF THE INVENTION

Wooden structural elements can be fastened together by driven fasteners such as common nails. Nails have a head and a shank. The head provides an impact surface onto which a force is applied to drive the fastener. The shank typically includes a pointed end opposite the head. The pointed end pierces the wooden structural elements, thus diminishing the force required to drive the nail into the structural element.

Nails are typically used to fasten an outer structural element to an inner structural element. The fastening of an outer and inner wooden structural elements is complete when the head is flush with the outer structural element and the shank has been driven entirely through the outer structural element into the inner structural element.

One specific use of nails is the securement of structural elements such as panelized structural sheathing (plywood, oriented strand board (OSB), etc.) to inner structural framing elements (e.g., joists, 2×4's, and roof rafters). Structural sheathing, as defined by the 1999 APA Panel Handbook & Grade Glossary, which is incorporated herein by reference, is the “structural covering, usually of wood panels or boards, on the outside surfaces of framing. It provides support for construction, snow and wind loads and backing for attaching exterior facing materials such as wall siding, roof shingles or underlayment in double layer floors.”

Structural sheathing is typically vulnerable to uplift in a high wind event such as a tornado or hurricane. Structural sheathing is also vulnerable to earthquake loads where large deflections of structural elements, to which the sheathing is secured, may occur. In highly stressed situations, of which high winds and earthquakes are but two examples, retention of the sheathing is necessary to minimize property damage.

There are three types of loading conditions that can occur to cause a nail to fail: an axial force (a load parallel to the nail shank), a shear force (a load perpendicular to the nail shank), and a combination of these two loading conditions. In a situation where a nail is axially loaded the nail can typically fail in one of two modes. A first failure mode is a withdrawal failure. A withdrawal failure occurs when the nail shank withdraws from the inner structural element allowing the outer structural element to separate from the inner structural element. A second failure mode is known as a “pull through” failure. A pull through failure occurs when the nail head is pulled through the outer structural element allowing the outer structural element to separate from the inner structural element. In a situation where the nail is loaded in a shear condition, there are numerous failure modes that can occur: withdrawal, pull through, wood crushing, and nail shank bending.

ASTM F1667-95 is the standard specification that covers driven fasteners including common nails. Head sizes for nails such as common nails are specified within this standard. Head size has typically been set for nails such as common nails based on the shank diameter and shank length.

ASTM F1667-95 includes a Table 16, which is the standard specification for nails for use mechanical drivers. The nails listed in this table are denoted as common nails. The nails listed in this table have a length and a shank diameter. However, nail head sizes are not listed in this specification. In Table 15 of the ASTM F1667-95 Standard Specification, the head sizes for common nails which are not mechanically driven are provided. Additionally, it should be noted that nails other than those listed in Table 16 (i.e., Tables 3-15 and 17-55) are typically not specifically specified for use with mechanical drivers and would typically be sold in bulk. However, some of the these other nails are available in a packaged form for use with a mechanical driver.

Head sizes for nails mechanically driven are typically smaller than those which are not mechanically driven (i.e., manually driven). Smaller head sizes are needed for mechanically driven nails because mechanically driven nails are sold more typically in a packaged collated form and there is often a requirement that the nail package be as dense as possible. In particular, packaged nails sold in a stick form typically require a minimum of spacing separating the nail shanks of adjacent nails. For this reason, large head sizes have typically not been used for nails sold in a packaged form. Additionally, small nail head sizes have been used for mechanically driven nails, because larger nail head sizes have been considered detrimental to easily passing through the mechanical driver. Consequently, smaller head sizes have been used for nails which are sold in package form to be driven by mechanical drivers than would be used for manually driven nails sold in bulk. Mechanical drivers also typically have a maximum nail head size that is usable with the mechanism.

NER-272 is the document that governs the design capacities allowed for power driver nails in wood framed construction. Additionally, it is the document that allows the power driven fastener to be utilized in lieu of a hand driven fastener in the major building codes (BOCA, ICBO, and SBCCI). The tables in NER-272 (5-22 and 28-37) specify the nail diameter, length and spacing for use in the attachment of structural sheathing to a framing member for a floor, wall or roof. The nails specified for these structural applications have a length between 1 ⅝ and 3 inches with a diameter between 0.092 and 0.148 in. Basically, it can be determined that a conventionally acceptable nail for sheathing is:

1. Manufactured from a form of steel wire;

2. Has a single round shank;

3. Has a shank diameter between 0.092 and 0.148 in.; and

4. Has a length between 1 ⅝ and 3 inches.

In addition to the four criteria listed above, it is also recognized that nails suitable for sheathing preferably have surface deformations, which are typically ring barbs, to provide a resistance to pull out.

There exists a need for a power driven nail that is more cost effective than existing nails that achieve the desired functional characteristics for sheathing nails. There particularly exists a need for such power driven sheathing nails that can be used for high shear applications, such as vertical shear walls, and where the sheathing panel is relatively thin in comparison with some other panels.

### SUMMARY OF THE INVENTION

The nail of the present invention is preferably manufactured from steel wire. The nail comprises a round head having a flat top surface suitable for being driven into a flush relationship with an exterior surface of a sheathing panel and a bottom surface. A single elongate shank that is integral with the head extends from the head bottom surface. The elongate shank further includes a point opposite the head and a plurality of surface deformations disposed on the shank. The surface deformations are configured to provide an enhanced resistance to panel separation by withdrawal of the nail shank from a framing structure. The shank has a substantially round cross-section having a shank diameter between 0.118 in. and 0.148 in. The nail further has a length between 1.75 inches and 2.75 inches. The head diameter provides an enlarged bottom head surface area for engaging the exterior surface of a sheathing panel to enhance resistance to panel separation by head pull through. The ratio of the head diameter to shank diameter is between 2.39 and 3.37.

The present invention also comprises a structure having a wooden structural sheathing panel secured to a framing structure through a plurality of the nails of the present invention. The present further comprises a method of fastening a wooden structural sheathing panel to a framing structure using a plurality of nails of the present invention. The present invention still further comprises a package of collated nails of the present invention.

An outer structural element is secured to an inner structural element through the use of the nail of the present invention. The nail of the present invention has particular benefits in applications such as the securement of outer structural elements such as panelized structural sheathing (plywood, orientated strand board (OSB), etc.) to inner structural framing elements such as joists, 2×4's, and roof rafters, which are typically used in framing structures.

The enlarged head provides a first clamping surface that is seated against an exterior surface of the sheathing panel into which the nail is first driven. The framing structure within which the deformed shank is disposed, is the second clamping surface. Through the provision of an enlarged head and a deformed shank, the ability of the nail to maintain the securement of the sheathing panel to the framing structure is enhanced. The nail of the present invention provides a nail head clamping surface of the necessary size to clamp a sheathing panel between the nail head and a framing structure, within which the deformed shank is disposed.

The shank of the present invention nail includes surface deformations such as rings to resist withdrawal. Accordingly, the deformed shank increases the force required to withdraw the nail shank from the framing structure (i.e. the withdrawal capacity).

The enlarged head of the present invention nail increases the surface area in contact with the exterior surface of a sheathing panel. The enlarged surface area subsequently ensures that a larger area of the sheathing panel would have to be pulled though the nail head for a pull through failure to occur. Accordingly, the pull through capacity of the sheathing panel is correspondingly increased through the use of the nail of the present invention.

The pull through capacity of a sheathing panel may be determined experimentally. The withdrawal capacity of the nail shank may also be determined experimentally. Accordingly, the nails of the present invention may be designed such the withdrawal capacity exceeds the pull through capacity.

The nail of the present invention also has particular benefits in applications such as the securement of outer structural elements such as structural sheathing used in sub-flooring to floor joists or other load bearing structural elements in the sub-flooring. If the nails used to secure the sheathing to the sub-flooring loosen, the floor will squeak. Squeaking floors present a nuisance and source of irritation for home dwellers where this phenomenon occurs. The nail of the present invention provides a clamping force on the sub-floor sheathing. This clamping force minimizes the possibility that nails used to fasten the sub-floor sheathing will loosen and that floors secured by the nails will be less likely to squeak.

Other advantages of the nail of the present invention are also derived from the enlarged diameter nail head. Nails should be driven until the nail head is flush with exterior surface of the sheathing. If the nail is power driven, there is an opportunity to drive a nail beyond the flush position, to a position beneath the exterior surface of the sheathing. The nail head compresses and damages the cellular structure of the sheathing as it is driven past the flush position. The strength of the sheathing is correspondingly lowered as a result of an over driven nail. The enlarged head of the nail of the present invention provides a large surface area that is more easily driven to a position where the head is contacting the exterior surface of the sheathing and is substantially flush with the sheathing surface. The large surface area of the enlarged nail head distributes the driving impact forces over a greater area, thus minimizing the possibility that the nail can be over driven. And, as the structural damage caused by overdriving the nail head is less likely to occur through the use of the nail of the present invention, pull through failures are correspondingly decreased.

These and other aspects and advantages of the invention can be realized by the embodiments of the nail of the invention. Other objects, aspects, and advantages of the embodiments of the invention will become apparent from the detailed description taken in conjunction with the drawings.

### BRIEF DESCRIPTION OF DRAWINGS

FIG. 1 is a side view of an embodiment of the nail of the present invention.

FIG. 1A is a top view of the embodiment of the nail of the present invention shown in FIG. 1 taken along line A-A.

FIG. 2 is a side view of the embodiment of the present invention shown in FIG. 1 used to secure a sheathing panel to a framing structure.

FIG. 3 is an enlarged side view, in cross-section of the embodiment of the present invention in FIG. 1 showing a portion of the deformed shank.

FIG. 4 is a side view of a plurality of nails of the embodiment of the present invention shown in FIG. 1 disposed in a collated package.

FIG. 5A is a side view of a plurality of nails of the embodiment of the present invention shown in FIG. 1 disposed in a collated stick package.

FIG. 5B is a side view of a plurality of nails of the embodiment of the present invention shown in FIG. 1 disposed in another embodiment of a collated stick package.

### DETAILED DESCRIPTION OF THE DRAWINGS

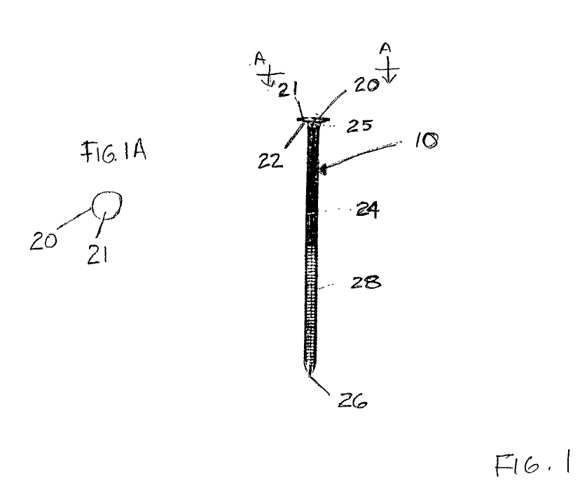

FIG. 1 shows an embodiment of the nail 10 of the present invention. The nail 10 is preferably manufactured from a form of steel wire. The steel is preferably plain, zinc coated, or stainless steel. The nail 10 includes an enlarged head 20 having a substantially planar, flat top surface 21 and a bottom surface 22. The enlarged head top surface 21 is adapted for receiving a driving impact force, and is particularly suited to be driven by a power driven tool, such as (but not limited to) a pneumatically operated driving tool. The flatness of the top surface 21 enables it to be driven into a flush relationship with the exterior surface of a sheathing panel. The head bottom surface 22 is adapted for contact with an exterior surface of a sheathing panel. The enlarged head 20 preferably has a substantially full round, preferably circular shape, as is shown in FIG. 1A.

The nail 10 also includes a single elongate shank 24 which is integral with the head and extends from the enlarged head bottom surface 22. The shank 24 includes a point 26 opposite the head and a middle position half way between the point 26 and the head 20. The shank 24 has a substantially round, preferably circular cross-sectional shape. The shank 24 preferably includes a plurality of surface deformations, which as shown are preferably spaced apart pointed rings 28. The rings 28 are preferably disposed between the middle position of the shank and the point 26, with the shank 24 being substantially smooth above the rings 28. The rings 28 are preferably not more than halfway up the shank 24 from the point 26, but may be less than halfway up the shank. Each of the rings 28 preferably has a tapered configuration with a larger diameter toward the nail head and a smaller diameter toward the nail point 26. All of the rings 28 preferably have the same configuration. The rings 28 function as a barb and easily penetrate into structural elements but are difficult to extract. The embodiment of the nail 10 shown in FIG. 1 is suitable for wooden structural applications.

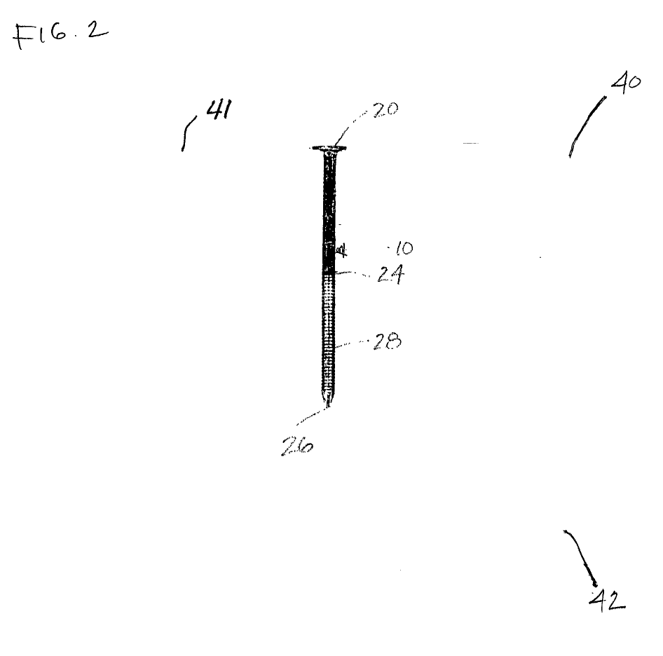

The nail 10 has specific application in the securement of an exterior panelized structural element, such as panelized sheathing, to inner structural framing elements, such as joists, 2×4's and roof rafters, which are commonly used in framing structures. FIG. 2 shows a structural configuration of an outer sheathing panel 40 in one set of examples, the panels 40 have a dimension in the range of about 4′ wide×8′ long×¼″ to 1-⅛″ thickness attached to an inner structural framing element 42 (e.g., a “two by four”) of a framing structure. As can be seen in this figure, the nail head 20 has been driven until the head 20 is substantially flush with the exterior surface 41 of the sheathing panel 40. The shank 24 is driven entirely through the sheathing panel 40 into the inner structural framing element 42. The shank rings 28 are disposed within the inner structural framing element 42.

The nail 10 provides a clamping force on the sheathing panel 40 securing the sheathing panel 40 to the inner structural framing element 42. Specifically, the nail 10 clamps the sheathing panel 40 between the enlarged head 20 and the inner structural framing element 42, within which the shank 24 is secured.

The enlarged head 20 engages the exterior surface 41 of the sheathing panel 42 with a contact surface having a large area. The large contact surface provided by the enlarged head 20 results in a situation where forces that would potentially loosen the sheathing panel 40 are distributed over the large surface area of the enlarged head. Accordingly, the large contact surface diminishes the chance that the sheathing panel can pull through the nail head 20. The shank rings 28 firmly engage the inner structural framing element 42, thus diminishing the likelihood that the shank can loosen or be pulled from the inner structural element 42 in comparison with an entirely smooth shank. The large surface area of the enlarged head 20 and the secure retention of the shank 24 results in the sheathing panel 40 essentially being clamped between the enlarged head 20 and the inner structural framing element 42.

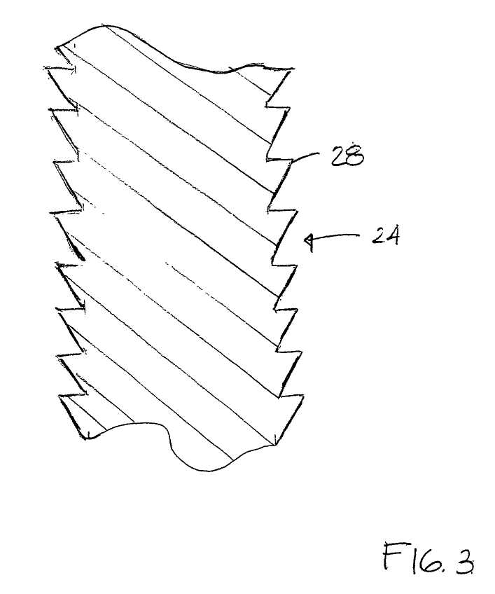

FIG. 3 is an enlarged cross-sectional side view of the embodiment of the present invention in FIG. 1 showing a portion of the shank 24 having the surface deformations. The deformations preferably include the aforementioned spaced apart rings 28, which are disposed along the lower portions of the shank, and preferably between the middle position of the shank and the nail point 26.

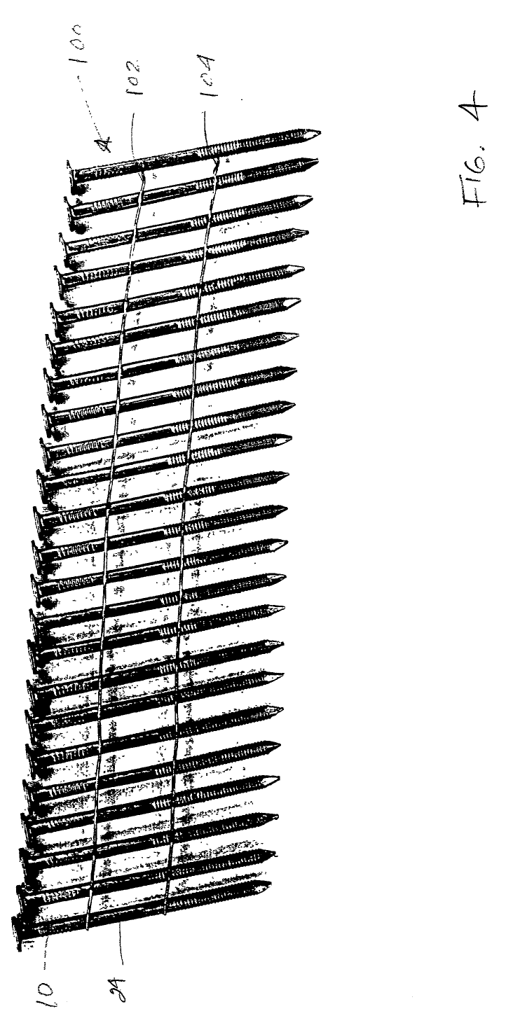

FIG. 4 shows a plurality of nails 10 of the present invention disposed in a collated package 100. Frangible wires 102 and 104 are welded to the shanks of each nail. Although the collated nail package 100 shown is in a flattened configuration, it is understood that the frangible wires are flexible and would allow the collated package to be disposed in a coiled configuration.

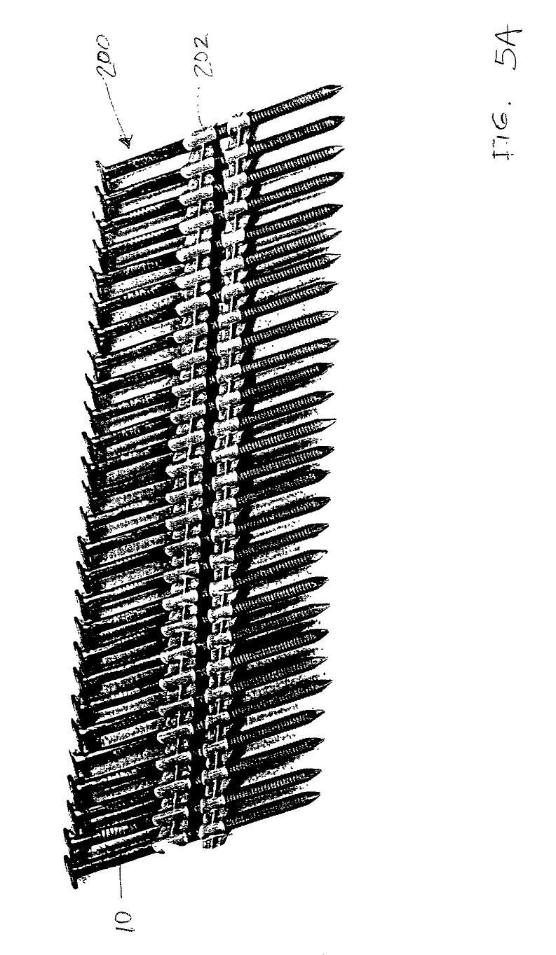

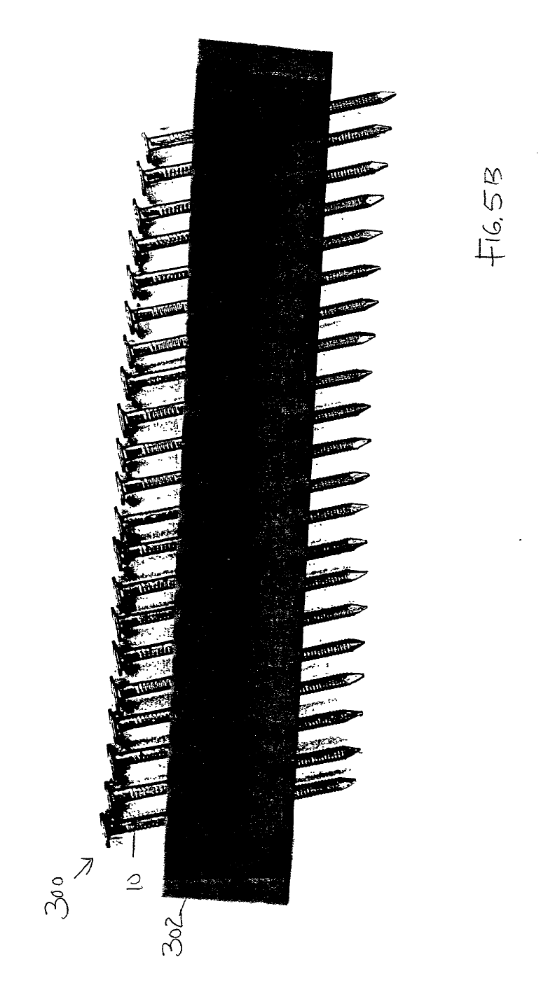

FIG. 5A shows a plurality of nails 10 of the present invention disposed in a collated package 200. A plastic binding element 202 is used to bind the plurality of nails into the collated package.

FIG. 5B shows a plurality of nails 10 of the present invention disposed in a collated package 300. A paper binding element 302 is used to bind the plurality of nails into the collated package.

The package of nails contemplated herein also includes nails connected together into a stick formation as known in the art.

A specific example of an embodiment of a nail manufactured in accordance with the principles of the present invention is as follows. The specific embodiment includes a shank length of about 2 ½ inches and a shank diameter of about 0.131 in. The head diameter is about 0.320 in. The ratio of the head diameter to the shank diameter is about 2.44. The shank length to shank diameter is about 19.08, and the shank length to head diameter is about 7.81.

In accordance with one aspect of the present invention a maximum head size of 0.320 in. is employed, as this corresponds to the maximum head size that can be used with certain existing commercially available mechanical nail drivers.

This specific embodiment of the present invention has particular utility in structural applications where a high shear strength is desired. For example, this specific embodiment of the present invention provides both strength and stiffness benefits in high shear situations where thin structural sheathing is attached to vertical framing elements, such as in shear walls. The specific embodiment of the nail has specific utility in structures where a significant resistance to withdrawal and to shear failure is required in addition to an enhanced resistance to pull through.

It is to be understood that the embodiment described above is only one out of many different possible preferred embodiments of the nail of the present invention. The various preferred nail embodiments of the present invention have a total length of between 1.75 inches to 2.75 inches. In addition, the shank has a round, preferably circular cross-section having a diameter between 0.118 and 0.148 in. The head has a diameter sized such that the ratio of the head diameter to the shank diameter is between 2.39 and 3.37. “Between 2.39 and 3.37” is defined to be greater than or equal to 2.39 and less than or equal to 3.37. A more preferred range of the ratio of the head diameter to the shank diameter for the invention would be between 2.42 and 3.00. A ratio of the head diameter to the shank diameter over 3.00 typically is more difficult to manufacture than a ratio below 3.00. Nails having a ratio above 3.00 typically require two blows to manufacture the nail head from the steel wire from which the nail is constructed. Nails having a ratio below 3.00 typically require only a single blow to manufacture the nail head.

It is also understood that a nail having a ratio of the head diameter to the shank diameter greater than 3.37 would be more suitable for the securement of shingles than for sheathing. It is further understood that nail lengths of less than about 1.75 inches would not provide the desired retention to the extent that is provided by the preferred embodiments of the invention, while in many instances nail lengths of greater than 2.75 inches would add material to the nail, but would not provide any significant increase to the retention of the nail within a framing structure.

In addition, because the maximum nail length of the present invention is less than the 3.0 inch nails that are commercially available for certain sheathing applications, it should be understood that the nail of the present invention is particularly suited for sheathing that is thinner than in such certain other sheathing applications. The shank diameter of between 0.118 in. and 0.148 in. makes the nail suited for high shear applications. The dimensions of the present invention maintain the cost-effectiveness of the nail without reducing structural integrity.

In accordance with NER-272 Section 3.3.2, the shank of the nails of the present invention preferably have a minimum average bending yield strength of 100 KSI (689 MPa) for nails having a nominal diameter of 0.135 in. or less. In addition, nails with diameters greater than 0.135 in. shall have a minimum average bending yield strength of 90 KSI (620 MPa). It must be noted, however, that the present invention includes nails that do not meet the minimum bend yield strength noted above, as not meeting this strength requirement may increase ductility and resistance to cyclic shear.

The preferred embodiments of the invention are preferably provided either in a bulk form or in a packaged collated form that is suitable for use with mechanical drivers such as pneumatic nail guns. Preferred embodiments of packaged collated nails of the present invention were shown in FIGS. 4, 5A and 5B. It is understood that collated nail packages having configurations other than what is shown in FIGS. 4, 5A and 5B are also possible within the scope of the invention.

The preferred embodiments of the invention preferably include a plurality of surface deformations such as rings on the lower portion of the shank. Shank deformations other than rings are also possible within the scope of the invention.

In the embodiments shown in FIGS. 1 through 5, nails suitable for sheathing are configured to provide high retention. It is preferable that the nail head diameter, and the corresponding surface area, are sized so that the benefits of the invention are achieved.

While advantageous embodiments have been chosen to illustrate the invention, it will be understood by those skilled in the art that various changes and modifications can be made therein without departing from the scope of the invention.

What is claimed is:

1. In combination, a wooden structural sheathing panel, a framing structure, and a series of nails extending through said sheathing panel into said framing structure so as to secure said sheathing panel in abutting relation to said framing structure and effectively prevent separation of said sheathing panel from said framing structure, each of the nails comprising:
a substantially round head having a flat top surface suitable for being driven into a flush relationship with an exterior surface of said sheathing panel and a bottom surface, the head further having a head diameter, the head diameter providing an enlarged bottom head surface area engaging the exterior surface of the wooden structural sheathing panel to enhance resistance to panel separation by head pull through;
a single elongate shank integral with the head and extending from the head bottom surface through said sheathing panel into said framing structure, the elongate shank further including a point disposed within said framing structure opposite the head, and a plurality of surface deformations formed on the shank, the surface deformations being configured to provide an enhanced resistance to sheathing panel separation by withdrawal of the nail shank from said framing structure, the shank further having a substantially round cross-section having a shank diameter between 0.118 and 0.148 in.;
wherein:
the nail is manufactured from steel wire;
the nail has a length between 1.75 inches and 2.75 inches; and
the ratio of the head diameter to shank diameter is between 2.39 and 3.37.

2. The combination of claim 1, wherein the surface deformations comprise a plurality of longitudinally spaced apart rings extending radially outwardly from the shank.

3. The combination of claim 1, wherein the surface deformations are disposed at least between a middle position on the shank, halfway between the point and the head, and the point.

4. The combination of claim 1, wherein the head is circular.

5. The combination of claim 1, wherein the shank has a circular cross-section.

6. The combination of claim 1, wherein the length is approximately 2.5 inches, the shaft diameter is approximately 0.131 in., the head diameter is approximately 0.320 in., and the ratio of head diameter to shaft diameter is approximately 2.44.

7. A method of fastening a wooden structural sheathing panel to a framing structure using a series of nails extending through the sheathing panel into the framing structure so as to secure the sheathing panel in abutting relation to the framing structure and effectively prevent separation of the sheathing panel from the framing structure by head pull through, the method comprising:
providing a nail manufactured from steel wire, the nail comprising:
a substantially round head having a flat top surface suitable for being driven into a flush relationship with an exterior surface of the sheathing panel and a bottom surface, the head further having a head diameter, the head diameter providing an enlarged bottom head surface area engaging the exterior surface of the wooden structural sheathing panel to enhance resistance to panel separation by head pull through;
a single elongate shank integral with the head and extending from the head bottom surface, the elongate shank further including a point opposite the head, and a plurality of surface deformations formed on the shank, the surface deformations being configured to provide an enhanced resistance to sheathing panel separation by withdrawal of the nail shank from the framing structure, the shank further having a substantially round cross-section having a shank diameter between 0.118 and 0.148 in.;
wherein:
the nail has a length between 1.75 inches and 2.75 inches; and
the ratio of the head diameter to shank diameter is between 2.39 and 3.37;
positioning the wooden structural sheathing panel in abutting relation with the framing structure; and
driving the nail through the wooden structural sheathing panel and into the framing structure until the nail head bottom surface engages an exterior surface of the wooden structural sheathing panel and at least a portion of the shank surface deformations are disposed within the framing element.

8. The method of claim 7, wherein the surface deformations comprise a plurality of longitudinally spaced apart rings extending radially outwardly from the shank.

9. The method of claim 7, wherein the surface deformations are disposed at least between a middle position on the shank, halfway between the point and the head, and the point.

10. The method of claim 7, wherein the head is circular.

11. The method of claim 7, wherein the shank has a circular cross-section.

12. The method of claim 7, wherein the length is approximately 2.5 inches, the shaft diameter is approximately 0.131 in., the head diameter is approximately 0.320 in., and the ratio of head diameter to shaft diameter is approximately 2.44.

13. A package of collated nails suitable for sheathing comprising:
a plurality of nails suitable for sheathing, each nail having:
a substantially round head having a flat top surface suitable for being driven into a flush relationship with an exterior surface of a sheathing panel and a bottom surface, the head further having a head diameter, the head diameter providing an enlarged bottom head surface area engaging the exterior surface of the wooden structural sheathing panel to enhance resistance to panel separation by head pull through;
a single elongate shank integral with the head and extending from the head bottom surface, the elongate shank further including a point opposite the head, and a plurality of surface deformations formed on the shank, the surface deformations being configured to provide an enhanced resistance to sheathing panel separation by withdrawal of the nail shank from a framing structure, the shank further having a substantially round cross-section having a shank diameter between 0.118 and 0.148 in.;
wherein:
each nail is manufactured from steel wire;
each nail has a length between 1.75 inches and 2.75 inches; and
the ratio of the head diameter to shank diameter of each nail is between 2.39 and 3.37; and
at least one attachment element constructed to temporarily attach the plurality of nails into a package.

14. The package of collated nails of claim 13, wherein the surface deformations of each nail comprise a plurality of longitudinally spaced apart rings extending radially outwardly from the shank.

15. The package of collated nails of claim 13, wherein the surface deformations are disposed at least between a middle position on the shank, halfway between the point and the head, and the point.

16. The package of collated nails of claim 13, wherein the head is circular.

17. The package of collated nails of claim 13, wherein the shank has a circular cross-section.

18. The package of collated nails of claim 13, wherein the length of each nail is approximately 2 inches, the shaft diameter is approximately 0.131 in., the head diameter is approximately 0.320 in., and the ratio of head diameter to shaft diameter is approximately 2.44.

19. The package of collated nails of claim 13, wherein the attachment element comprises a frangible plastic binding element attached to each nail of the package.

20. The package of collated nails of claim 13, wherein the attachment element comprises a frangible wire welded to each nail of the package.

21. The package of collated nails of claim 13, wherein the attachment element comprises frangible paper attached to each nail of the package.

22. A power driven nail suitable for sheathing comprising:
a substantially round head having a flat top surface suitable for being driven into a flush relationship with an exterior surface of a sheathing panel and a bottom surface, the head further having a head diameter, the head diameter providing an enlarged bottom head surface area engaging the exterior surface of the wooden structural sheathing panel to enhance resistance to panel separation by head pull through;
a single elongate shank integral with the head and extending from the head bottom surface, the elongate shank further including a point opposite the head, and a plurality of surface deformations formed on the shank, the surface deformations being configured to provide an enhanced resistance to sheathing panel separation by withdrawal of the nail shank from a framing structure, the shank further having a substantially round cross-section having a shank diameter between 0.118 and 0.148 in.;
wherein:
the nail is manufactured from steel wire;
the nail has a length between 1.75 inches and 2.75 inches; and
the ratio of the head diameter to shank diameter is between 2.39 and 3.37.

23. The nail of claim 22, wherein the surface deformations comprise a plurality of longitudinally spaced apart rings extending radially outwardly from the shank.

24. The nail of claim 22, wherein the surface deformations are disposed at least between a middle position on the shank, halfway between the point and the head, and the point.

25. The nail of claim 22, wherein the head is circular.

26. The nail of claim 22, wherein the shank has a circular cross-section.

27. The nail of claim 22, wherein the length is approximately 2.5 inches, the shaft diameter is approximately 0.131 in., the head diameter is approximately 0.320 in., and the ratio of head diameter to shaft diameter is approximately 2.44.
